(19) United States
(12) Patent Application Publication
(10) Pub. No.: US 2026/0186275 A1
(43) Pub. Date: Jul. 2, 2026

(54) OPTICAL ELEMENT AND A CAMERA MODULE HAVING THE SAME

(71) Applicant: SAMSUNG ELECTRO-MECHANICS CO., LTD., Suwon-si (KR)

(72) Inventors: Geon Hwi PARK, Suwon-si (KR); Ho Bin GO, Suwon-si (KR); So Mi YANG, Suwon-si (KR); Hag Chul KIM, Suwon-si (KR); Tae Yeon LIM, Suwon-si (KR)

(73) Assignee: SAMSUNG ELECTRO-MECHANICS CO., LTD., Suwon-si (KR)

(21) Appl. No.: 19/318,029

(22) Filed: Sep. 3, 2025

(30) Foreign Application Priority Data
Dec. 26, 2024 (KR) 10-2024-0197074

(51) Int. Cl. G02B 13/00; G02B 17/08; G02B 27/00; G03B 17/17

(52) U.S. Cl. CPC G02B 13/007; G02B 17/0856; G02B 27/0018; G03B 17/17

(57) ABSTRACT

An optical element includes an incident surface, a first reflective surface, a second reflective surface, and an exit surface sequentially formed from an object side-surface. The first reflective surface and the exit surface have different size of radii of curvature.

### CROSS-REFERENCE TO RELATED APPLICATIONS

This application claims the benefit under 35 USC 119(a) of Korean Patent Application No. 10-2024-0197074 filed on Dec. 26, 2024, in the Korean Intellectual Property Office, the entire disclosure of which is incorporated herein by reference for all purposes.

### BACKGROUND

### 1. Field

The present disclosure relates to an optical element and a camera module having the same.

### Description of the Background

In general, portable electronic devices include a camera module for capturing a still image or recording a moving image. For example, a camera module can be mounted on a mobile phone, laptop, a game console, or the like. Such portable electronic devices are generally manufactured in compact or small sizes to increase user convenience in terms of device portability. For example, a camera module mounted on a portable electronic device can include an optical path conversion means configured to enable changing or transforming the optical path. The optical path conversion means reflects or refracts the optical path of the imaging lens system extending in a first direction, into a further direction, intersecting the first direction, thereby enabling the thinning and miniaturization of the camera module. However, since conventional camera modules simply change the direction of the optical path through an optical path conversion means, there is a limit to miniaturizing (rendering compact) the camera module.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical element includes an incident surface, a first reflective surface, a second reflective surface, and an exit surface sequentially disposed from an object-side surface. The first reflective surface and the exit surface have different size of radii of curvature.

A radius of curvature of the exit surface may be smaller than a radius of curvature of the first reflective surface.

The exit surface may have a convex or concave shape.

The incident surface and the first reflective surface may have different size of radii of curvature.

A radius of curvature of the incident surface may be smaller than the radius of curvature of the first reflective surface.

The incident surface may have a convex or concave shape.

An angle between the exit surface and the second reflective surface may be determined within a range of 8 to 32 degrees.

The optical element may further include a light-blocking member disposed on the first reflective surface and the second reflective surface.

A camera module may include the optical element, an imaging lens system disposed on an object side of the incident surface, and an image sensor disposed to oppose the exit surface.

In another general aspect, an optical element includes an incident portion, a first reflective portion, a second reflective portion, and an exit portion sequentially formed along an optical path, wherein a size of the incident portion is greater than a size of the exit portion.

The first reflective portion and the exit portion may have different size of radii of curvature.

The first reflective portion and the exit portion may be disposed adjacently and alongside each other.

The exit portion may be formed to be convex or concave.

The incident portion may be formed to be convex or concave.

The optical element may further include a light-blocking member disposed on the first reflective portion and the second reflective portion.

A camera module may include the optical element, an imaging lens system disposed on an object side of the incident surface, and an image sensor disposed to oppose the exit surface.

Other features and aspects will be apparent from the following detailed description, the drawings, and the claims.

### BRIEF DESCRIPTION OF DRAWINGS

FIG. 1 illustrates an optical element according to an embodiment of the present disclosure.

FIG. 2 is a first modified example of the optical element illustrated in FIG. 1.

FIG. 3 is a second modified example of the optical element illustrated in FIG. 1.

FIG. 4 is a third modified example of the optical element illustrated in FIG. 1.

FIG. 5 is a configuration diagram of a camera module according to an embodiment of the present disclosure.

FIG. 6 is a modified example of the camera module illustrated in FIG. 5.

FIG. 7 illustrates an optical element according to another embodiment of the present disclosure.

FIG. 8 is a first modified example of the optical element illustrated in FIG. 7.

FIG. 9 is a second modified example of the optical element illustrated in FIG. 7.

FIG. 10 is a third modified example of the optical element illustrated in FIG. 7.

FIG. 11 is a configuration diagram of a camera module according to another embodiment of the present disclosure.

FIG. 12 is a modified example of the camera module illustrated in FIG. 11.

Throughout the drawings and the detailed description, unless otherwise described the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

In the following description of the present disclosure, terms referring to the components of the present disclosure may be used in consideration of the function of each component, and should not be understood as having meanings limiting the technical components of the present disclosure.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In this disclosure, an object side-surface of an optical element refers to a surface that is closer to a subject to be photographed among an incident surface (incident portion) and an exit surface (exit portion) of the optical element, and an image side-surface of the optical element refers to a surface that is closer to an imaging plane (or image sensor) among the incident surface (incident portion) and the exit surface (exit portion) of the optical element. In addition, in this specification, a distance between an incident surface (an incident portion), a first reflective surface (a first reflective portion), a second reflective surface (a second reflective portion), and the exit surface (an exit portion) is calculated based on an optical axis. Additionally, in the present specification and claims, the incident surface, the first reflective surface, the second reflective surface, and the exit surface may refer to substantially the same configurations as the incident portion, the first reflective portion, the second reflective portion, and the exit portion.

An aspect of the present disclosure is to provide an optical element enabling disposition of an imaging lens system having a long optical path in a limited space, and a camera module including the same.

In addition, another aspect of the present disclosure is to minimize a flare phenomenon caused by internal reflection by the optical path conversion member.

According to an aspect of the present disclosure, miniaturization of a camera module (small and compact) can be enabled.

An optical element according to a first aspect of the present disclosure may include an incident surface, a first reflective surface, a second reflective surface, and an exit surface sequentially formed from an object side-surface. However, the configuration of optical elements according to the first aspect is not limited to the aspect described above. For example, the optical element according to the first aspect may further include a third reflective surface and a fourth reflective surface. In the optical element according to the first aspect, the first reflective surface and the exit surface may have a unique relationship. For example, in the optical element according to the first aspect, the first reflective surface and the exit surface may have different size of radii of curvature.

An optical element according to a second aspect of the present disclosure may include an incident portion, a first reflective portion, a second reflective portion, and an exit portion sequentially formed along an optical path. However, the configuration of optical elements according to the second aspect is not limited to the aspect described above. For example, the optical element according to the second aspect may further include a third reflective portion and a fourth reflective portion. In the optical element according to the second aspect, the incident portion and the exit portion may have a unique relationship. For example, in the optical element according to the second aspect, a size of the incident portion may be greater than a size of the exit portion.

An optical element according to a third aspect of the present disclosure may include an incident surface, a first reflective surface, a second reflective surface, and an exit surface sequentially formed from an object side-surface. However, the configuration of optical elements according to the third aspect is not limited to the aspect described above. For example, the optical element according to the third aspect may further include a third reflective surface and a fourth reflective surface. The optical elements according to the third aspect may be configured to have refractive power. For example, in the optical element according to the third aspect, the incident surface or the exit surface may be formed to be convex or concave.

An optical element according to a fourth aspect of the present disclosure may include an incident surface, a first reflective surface, a second reflective surface, and an exit surface sequentially formed from an object side-surface. However, the configuration of optical elements according to the fourth aspect is not limited to the aspect described above. For example, the optical element according to the fourth aspect may further include a third reflective surface and a fourth reflective surface. The optical element according to the fourth aspect may be configured such that a radius of curvature of the incident surface or the exit surface is smaller than the radius of curvature of either the first reflective surface or the second reflective surface. As an example, in the optical element according to the fourth aspect, the radius of curvature of the exit surface may be smaller than the radius of curvature of the first reflective surface. As another example, in the optical element according to the fourth aspect, the radius of curvature of the incident surface may be smaller than the radius of curvature of the second reflective surface.

A camera module according to an embodiment of the present disclosure may include an imaging lens system, an image sensor, and may be configured to further include any one of the optical elements according to the first to fourth aspects.

Hereinafter, an optical element and a camera module according to embodiments of the present disclosure will be described based on the attached drawings.

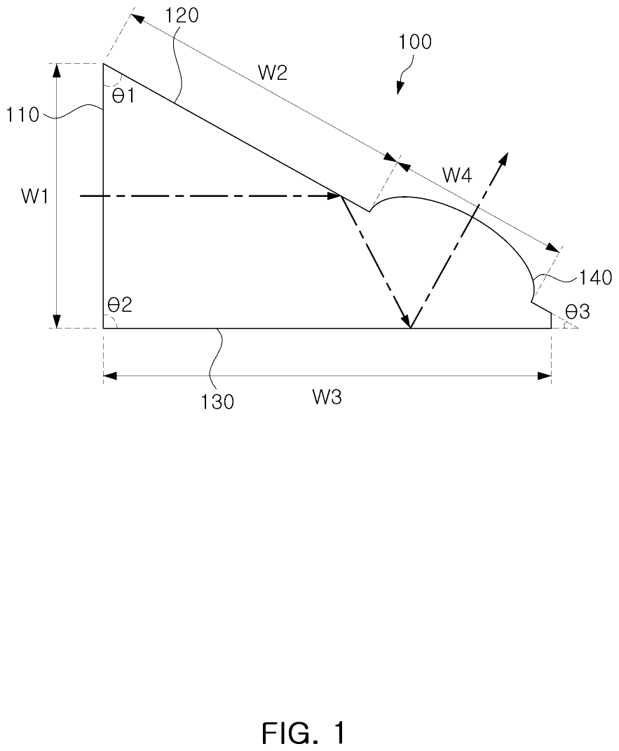

First, an optical element according to an embodiment will be described with reference to FIGS. 1 to 4.

An optical element 100 according to the present embodiment may include an incident surface 110, a first reflective surface 120, a second reflective surface 130, and an exit surface 140. The incident surface 110, the first reflective surface 120, the second reflective surface 130, and the exit surface 140 may be formed sequentially. As an example, the incident surface 110, the first reflective surface 120, the second reflective surface 130, and the exit surface 140 may be formed sequentially from an object side. As another example, the incident surface 110, the first reflective surface 120, the second reflective surface 130, and the exit surface 140 may be formed sequentially along an optical path.

The incident surface 110 may be disposed closest to the object side in the optical element 100. For example, the incident surface 110 may be a portion of the optical element 100 where inflow of light reflected from an object side first occurs. The incident surface 110 may have a predetermined size. For example, the incident surface 110 may have a first size W1. The incident surface 110 may have a predetermined size of a radius of curvature. In the embodiment, the incident surface 110 may have a substantially infinite radius of curvature (substantially a plane). However, the size of the radius of curvature of the incident surface 110 is not limited to infinity. For example, the radius of curvature of the incident surface 110 may be formed to have a different size than a radius of curvature of the first reflective surface. As a specific example, the radius of curvature of the incident surface 110 may be smaller than the radius of curvature of the first reflective surface 120.

The first reflective surface 120 may be formed to oppose the incident surface 110 and may be configured to reflect light incident from the incident surface 110 first. For example, the first reflective surface 120 may be configured to have an angle of less than 90 degrees with respect to the incident surface 110. As a specific example, a first angle θ1 between the first reflective surface 120 and the incident surface 110 may be approximately 60 degrees. However, the size of the first angle θ1 is not limited to 60 degrees. For example, the first angle θ1 may be changed within a range of 58 degrees to 82 degrees. The first reflective surface 120 may have a predetermined size. For example, the first reflective surface 120 may have a second size W2. The second size W2 may be substantially greater than the first size W1. However, a size relationship between the first size W1 and the second size W2 is not limited to the aspect described above. The first reflective surface 120 may have a predetermined size of a radius of curvature. In the embodiment, the first reflective surface 120 may have a substantially infinite radius of curvature (substantially a plane). However, the size of the radius of curvature of the first reflective surface 120 is not limited to infinity.

The second reflective surface 130 is formed to oppose the first reflective surface 120 and may be configured to reflect light incident from the first reflective surface 120 to the exit surface 140. The second reflective surface 130 may be configured to have a second angle θ2 of substantially 90 degrees with respect to the incident surface 110. For example, the second angle θ2 between the second reflective surface 130 and the incident surface 110 may be 90 degrees. However, the size of the second angle θ2 is not limited to 90 degrees. The second reflective surface 130 may have a predetermined size. For example, the second reflective surface 130 may have a third size W3. The third size W3 may be substantially greater than the first size W1 and the second size W2. The second reflective surface 130 may have a predetermined size of a radius of curvature. In the embodiment, the second reflective surface 130 may have a substantially infinite radius of curvature (substantially a plane). However, the size of the radius of curvature of the second reflective surface 130 is not limited to infinity.

The exit surface 140 may be formed to oppose the second reflective surface 130 and may be configured to emit light reflected from the second reflective surface 130. The exit surface 140 may be disposed to form a substantially acute angle with respect to the second reflective surface 130. For example, the third angle θ3 between the exit surface 140 and the second reflective surface 130 may be substantially 30 degrees. However, the size of the third angle θ3 is not limited to 30 degrees. For example, the third angle θ3 may be changed within a range of 8 to 32 degrees. The exit surface 140 may be formed parallel to the first reflective surface 120. For example, the exit surface 140 may be formed adjacent to the first reflective surface 120 on the same plane. The exit surface 140 may have a predetermined size. For example, the exit surface 140 may have a fourth size W4. The fourth size W4 may be smaller than at least any one of the first size W1 to the third size W3. As an example, the fourth size W4 may be smaller than the first size W1. As another example, the fourth size W4 may be smaller than the first size W1 to the third size W3. The exit surface 140 may have a predetermined size of a radius of curvature. For example, the radius of curvature of the exit surface 140 may be formed to a different size from the radius of curvature of the first reflective surface. As a specific example, in the present embodiment, the exit surface 140 may be smaller than either the radius of curvature of the first reflective surface 120 or the radius of curvature of the second reflective surface 130.

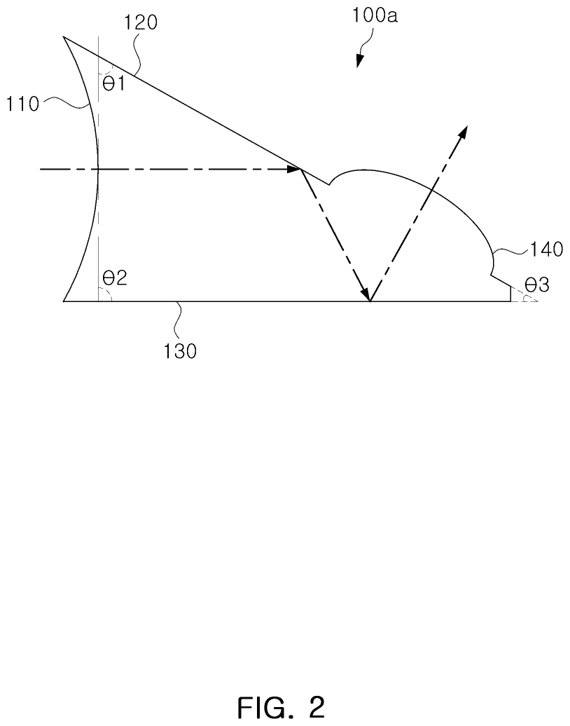

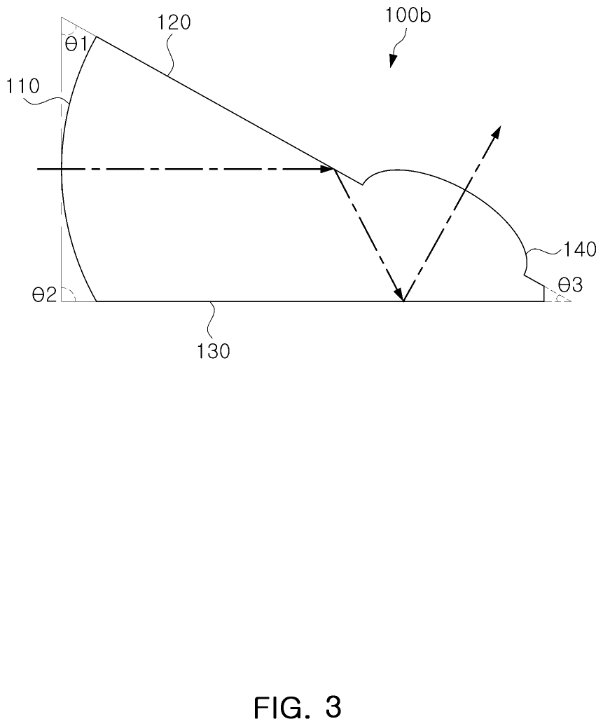

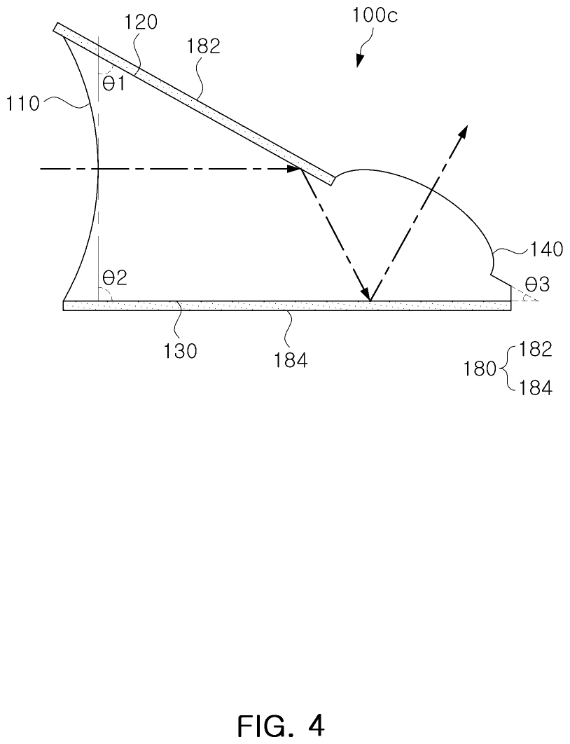

The optical element 100 may be configured to have refractive power. As an example, the exit surface 140 in the optical element 100 may have a convex shape. However, the exit surface 140 is not limited to the convex shape. The optical element 100 may be configured to easily have aberration correction or change of a focal length. As an example, an optical element 100a according to a first modified example may have a concave shape at the incident surface 110 as illustrated in FIG. 2. As another example, an optical element 100b according to the second modified example may have a convex shape at the incident surface 110 as illustrated in FIG. 3. The optical element 100 may be configured to reduce a flare phenomenon. As an example, an optical element 100c according to the third modified example may further include light-blocking members (180: 182 and 184) formed on the first reflective surface 120 and the second reflective surface 130 as illustrated in FIG. 4.

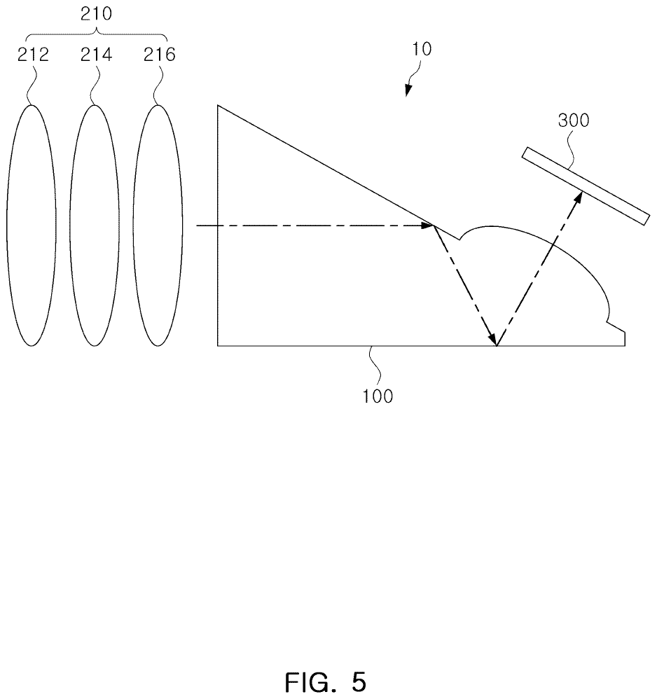

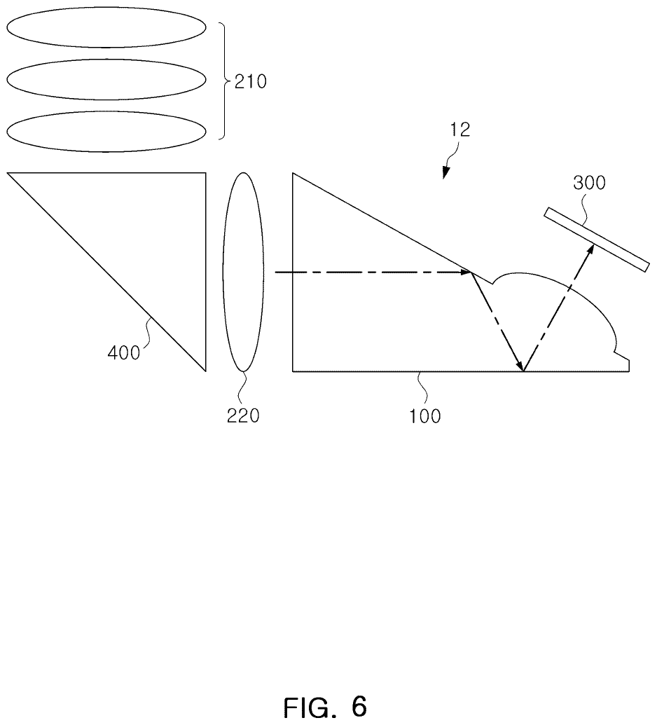

Next, a camera module according to an embodiment will be described with reference to FIGS. 5 and 6.

A camera module 10 according to the present embodiment may include an optical element 100, a first imaging lens system 210, and an image sensor 300. However, configuration of the camera module 10 is not limited to the optical element 100, the first imaging lens system 210, and the image sensor 300 described above. As an example, the camera module 10 may further include a filter disposed between the optical element 100 and the image sensor 300. As another example, the camera module 10 may further include a stop, or the like, disposed on an object side of the first imaging lens system 210 or between the first imaging lens system 210 and the optical element 100.

The first imaging lens system 210, the optical element 100, and the image sensor 300 may be sequentially disposed along an optical path. For example, the first imaging lens system 210 may be disposed on an object side of the optical element 100, and the image sensor 300 may be disposed on an image side of the optical element 100.

The optical element 100 may be any one of the optical elements according to the embodiments described above. As an example, the optical element 100 may have the same form as that illustrated in FIG. 1. As another example, the optical element 100 may have any of the forms illustrated in FIGS. 2 to 4. However, the optical element 100 is not limited to the forms illustrated in FIGS. 1 to 4.

The first imaging lens system 210 may include one or more lenses. For example, the first imaging lens system 210 may include three lenses 212, 214, and 216. However, the number of lenses configuring the first imaging lens system 210 is not limited to three. For example, the first imaging lens system 210 may be composed of two or less lenses or four or more lenses. The first imaging lens system 210 may be configured to have a predetermined size of a back focal length. For example, the back focal length of the first imaging lens system 210 may be greater than a distance from the incident surface 110 to the exit surface 140 of the optical element 100.

The image sensor 300 may be configured to change light passing through the first imaging lens system 210 and the optical element 100 into an electrical signal. For example, the image sensor 300 may be configured in CMOS or CCD form. The image sensor 300 may be disposed to oppose one surface of the optical element 100. For example, the image sensor 300 may be disposed to oppose the exit surface 140 of the optical element 100.

The camera module 10 configured in this manner may have an advantage of being able to secure a sufficient distance from the first imaging lens system 210 to the image sensor 300. Additionally, since the camera module 10 according to the present embodiment has the exit surface 140 of the optical element 100 closest to the image sensor 300 with a predetermined form, light incident through the first imaging lens system 210 may be effectively focused on the image sensor 300.

A camera module 12 according to a modified form may further include a second imaging lens system 220 and a prism 400 as illustrated in FIG. 6. The prism 400 and the second imaging lens system 220 may be sequentially disposed along an optical path between the first imaging lens system 210 and the optical element 100. To elaborate, the prism 400 may be disposed on an image side of the first imaging lens system 210, and the second lens system 220 may be disposed between the prism 400 and the optical element 100. The second lens system 220 may be composed of a single lens. However, the number of lenses configuring the second imaging lens system 220 is not limited to one. For example, the second imaging lens system 220 may be composed of two or more lenses.

The camera module 12 configured in this manner may have an advantage of being able to concentrate main components of the camera module 12 into a limited space through the optical element 100 and the prism 400. Therefore, the camera module 12 according to the present embodiment may be easily mounted in a small terminal having limited space for mounting. Additionally, since the camera module 12 according to the present embodiment may include a plurality of spatially separated first imaging lens systems 210 and second imaging lens systems 220, it may be changed to a form enabling focus magnification adjustment (zoom-in and zoom-out).

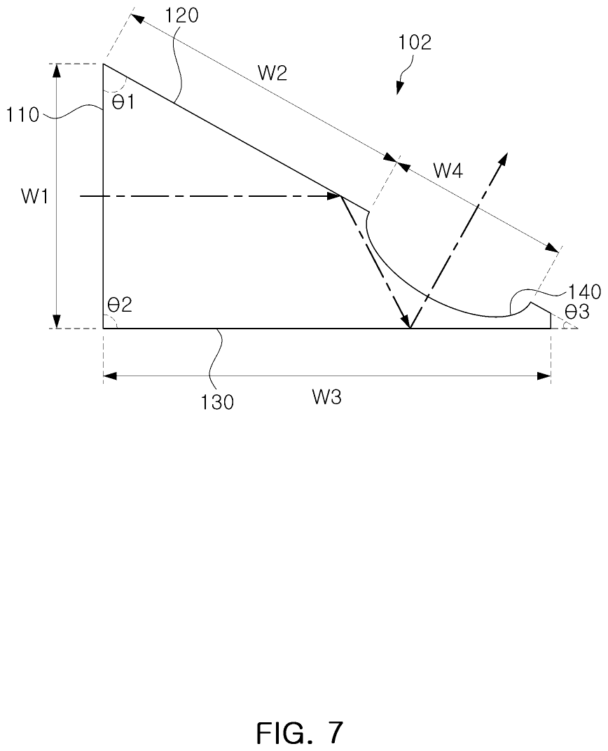

Next, an optical element according to another embodiment will be described with reference to FIGS. 7 to 10.

An optical element 102 according to the present embodiment may include an incident surface 110, a first reflective surface 120, a second reflective surface 130, and an exit surface 140. The incident surface 110, the first reflective surface 120, the second reflective surface 130, and the exit surface 140 may be formed sequentially. As an example, the incident surface 110, the first reflective surface 120, the second reflective surface 130, and the exit surface 140 may be formed sequentially from an object side. As another example, the incident surface 110, the first reflective surface 120, the second reflective surface 130, and the exit surface 140 may be formed sequentially along an optical path.

The incident surface 110 may be disposed closest to the object side in the optical element 102. For example, the incident surface 110 may be a portion the optical element 102 where inflow of light reflected from an object side first occurs. The incident surface 110 may have a predetermined size. For example, the incident surface 110 may have a first size W1. The incident surface 110 may have a predetermined size of a radius of curvature. In the embodiment, the incident surface 110 may have a substantially infinite radius of curvature (substantially a plane). However, the size of the radius of curvature of the incident surface 110 is not limited to infinity. For example, the radius of curvature of the incident surface 110 may be formed to a different size than a radius of curvature of the first reflective surface. As a specific example, the radius of curvature of the incident surface 110 may be smaller than the radius of curvature of the first reflective surface 120.

The first reflective surface 120 is formed to oppose the incident surface 110 and may be configured to first reflect light incident from the incident surface 110. For example, the first reflective surface 120 may be configured to have an angle of less than 90 degrees with respect to the incident surface 110. As a specific example, the first angle θ1 between the first reflective surface 120 and the incident surface 110 may be approximately 60 degrees. However, the size of the first angle θ1 is not limited to 60 degrees. For example, the first angle θ1 may be changed within a range of 58 degrees to 82 degrees. The first reflective surface 120 may have a predetermined size. For example, the first reflective surface 120 may have a second size W2. The second size W2 may be substantially greater than the first size W1. However, a size relationship between the first size W1 and the second size W2 is not limited to the aspect described above. The first reflective surface 120 may have a predetermined size of a radius of curvature. In the embodiment, the first reflective surface 120 may have a substantially infinite radius of curvature (substantially a plane). However, the size of the radius of curvature of the first reflective surface 120 is not limited to infinity.

The second reflective surface 130 is formed to oppose the first reflective surface 120 and may be configured to reflect light incident from the first reflective surface 120 to the exit surface 140. The second reflective surface 130 may be configured to have a second angle θ2 of substantially 90 degrees with respect to the incident surface 110. For example, the second angle θ2 between the second reflective surface 130 and the incident surface 110 may be 90 degrees. However, the size of the second angle θ2 is not limited to 90 degrees. The second reflective surface 130 may have a predetermined size. For example, the second reflective surface 130 may have a third size W3. The third size W3 may be substantially greater than the first size W1 and the second size W2. The second reflective surface 130 may have a predetermined size of a radius of curvature. In the embodiment, the second reflecting surface 130 may have a substantially infinite radius of curvature (substantially a plane). However, the size of the radius of curvature of the second reflective surface 130 is not limited to infinity.

The exit surface 140 is formed to oppose the second reflective surface 130 and may be configured to emit light reflected from the second reflective surface 130. The exit surface 140 may be disposed to form a substantially acute angle with respect to the second reflective surface 130. For example, the third angle θ3 between the exit surface 140 and the second reflective surface 130 may be substantially 30 degrees. However, the size of the third angle θ3 is not limited to 30 degrees. For example, the third angle θ3 may be changed within a range of 8 to 32 degrees. The exit surface 140 may have a predetermined size. For example, the exit surface 140 may have a fourth size W4. The fourth size W4 may be smaller than at least any one of the first size W1 to the third size W3. As an example, the fourth size W4 may be smaller than the first size W1. As another example, the fourth size W4 may be smaller than the first size W1 to the third size W3. The exit surface 140 may have a predetermined size of a radius of curvature. In the present embodiment, the exit surface 140 may be smaller than either the radius of curvature of the first reflective surface 120 or the radius of curvature of the second reflective surface 130.

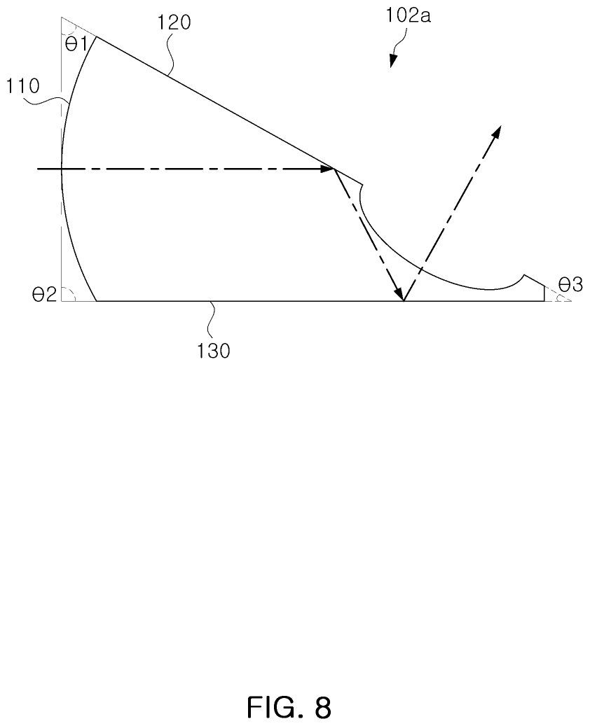

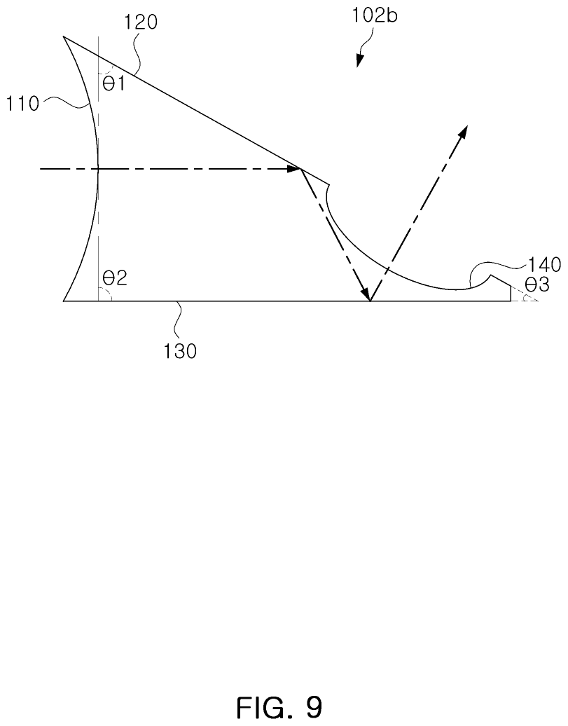

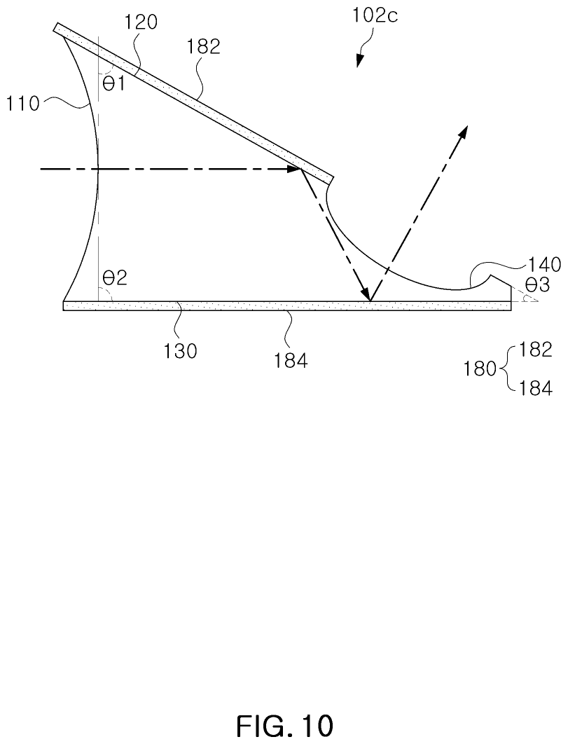

The optical element 102 may be configured to have refractive power. As an example, the exit surface 140 in the optical element 100 may have a concave shape. However, the exit surface 140 is not limited to the concave shape. The optical element 102 may be configured to easily have aberration correction or change of a focal length. As an example, an optical element 102a according to a first modified example may have a convex shape at the incident surface 110 as illustrated in FIG. 8. As another example, an optical element 102b according to the second modified example may have a concave shape at the incident surface 110 as illustrated in FIG. 9. The optical element 102 may be configured to reduce a flare phenomenon. As an example, an optical element 102c according to the third modified example may further include light-blocking members (180: 182 and 184) formed on the first reflective surface 120 and the second reflective surface 130 as illustrated in FIG. 10.

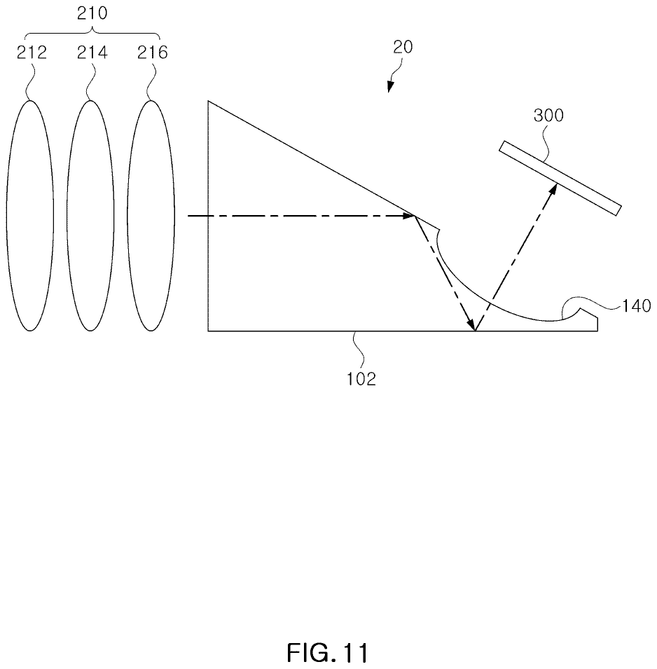

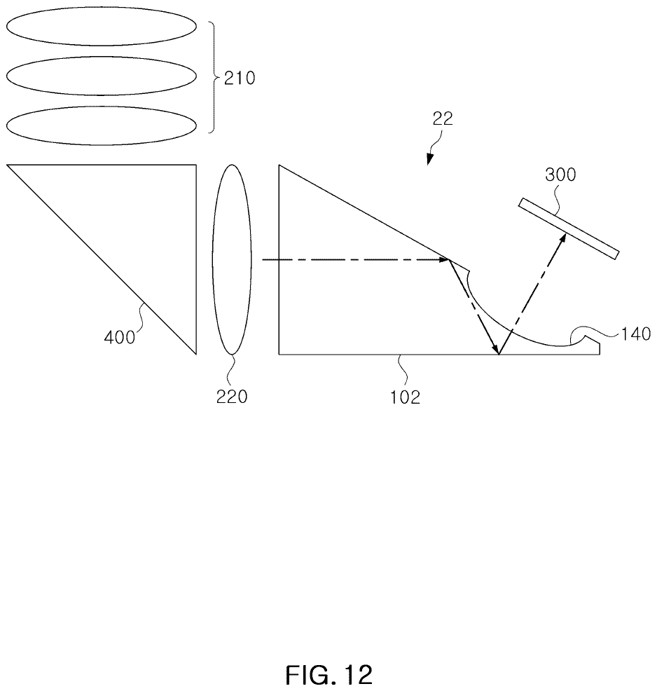

Next, a camera module according to another embodiment will be described with reference to FIGS. 11 and 12.

A camera module 20 according to the present embodiment may include an optical element 102, a first imaging lens system 210, and an image sensor 300. However, configuration of a camera module 20 is not limited to the optical element 102, the first imaging lens system 210, and the image sensor 300 described above. As an example, the camera module 20 may further include a filter disposed between the optical element 102 and the image sensor 300. As another example, the camera module 20 may further include a stop, or the like, disposed on an object side of the first imaging lens system 210 or between the first imaging lens system 210 and the optical element 100.

The first imaging lens system 210, the optical element 102, and the image sensor 300 may be sequentially disposed along an optical path. For example, the first imaging lens system 210 may be disposed on an object side of the optical element 102, and the image sensor 300 may be disposed on an image side of the optical element 102.

The optical element 102 may be any one of the optical elements according to the embodiments described above. As an example, the optical element 102 may have the same form as that illustrated in FIG. 7. As another example, the optical element 102 may have any of the forms illustrated in FIGS. 8 to 10. However, the optical element 102 is not limited to the forms illustrated in FIGS. 7 to 10.

The first imaging lens system 210 may include one or more lenses. For example, the first imaging lens system 210 may include three lenses 212, 214, and 216. However, the number of lenses configuring the first imaging lens system 210 is not limited to three. For example, the first imaging lens system 210 may be composed of two or less lenses or four or more lenses. The first imaging lens system 210 may be configured to have a predetermined size of a back focal length. For example, the back focal length of the first imaging lens system 210 may be greater than a distance from the incident surface 110 to the exit surface 140 of the optical element 102.

The image sensor 300 may be configured to change light passing through the first imaging lens system 210 and the optical element 102 into an electrical signal. For example, the image sensor 300 may be configured in CMOS or CCD form. The image sensor 300 may be disposed to oppose one surface of the optical element 102. For example, the image sensor 300 may be disposed to oppose the exit surface 140 of the optical element 102.

The camera module 20 configured in this manner may have an advantage of being able to secure a sufficient distance from the first imaging lens system 210 to the image sensor 300. Additionally, since the camera module 20 according to the present embodiment may have the exit surface 140 of the optical element 100 closest to the image sensor 300 with a predetermined form, light incident through the first imaging lens system 210 may be effectively focused on the image sensor 300.

A camera module 22 according to a modified form may further include a second imaging lens system 220 and a prism 400 as illustrated in FIG. 12. The prism 400 and the second imaging lens system 220 may be sequentially disposed along an optical path between the first imaging lens system 210 and the optical element 102. To elaborate, the prism 400 may be disposed on an image side of the first imaging lens system 210, and the second imaging lens system 220 may be disposed between the prism 400 and the optical element 102. The second imaging lens system 220 may be composed of a single lens. However, the number of lenses configuring the second imaging lens system 220 is not limited to one. For example, the second imaging lens system 220 may be composed of two or more lenses.

The camera module 22 configured in this manner may have an advantage of being able to concentrate main components of the camera module 22 into a limited space through the optical element 102 and the prism 400. Therefore, the camera module 22 according to the present embodiment may be easily mounted in a small terminal having limited space for mounting. Additionally, since the camera module 22 according to the present embodiment may include a plurality of spatially separated first imaging lens systems 210 and second imaging lens systems 220, it may be changed to a form enabling focus magnification adjustment (zoom-in and zoom-out).

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. An optical element comprising:
an incident surface, a first reflective surface, a second reflective surface, and an exit surface sequentially formed from an object side-surface,
wherein the first reflective surface and the exit surface have different size of radii of curvature.

2. The optical element of claim 1, wherein a radius of curvature of the exit surface is smaller than a radius of curvature of the first reflective surface.

3. The optical element of claim 1, wherein the exit surface has a convex or concave shape.

4. The optical element of claim 1, wherein the incident surface and the first reflective surface have different size of radii of curvature.

5. The optical element of claim 4, wherein a radius of curvature of the incident surface is smaller than the radius of curvature of the first reflective surface.

6. The optical element of claim 4, wherein the incident surface has a convex or concave shape.

7. The optical element of claim 1, wherein an angle between the exit surface and the second reflective surface is determined within a range of 8 to 32 degrees.

8. The optical element of claim 1, further including a light-blocking member disposed on the first reflective surface and the second reflective surface.

9. A camera module comprising:
the optical element of claim 1;
an imaging lens system disposed on an object side of the incident surface; and
an image sensor disposed to oppose the exit surface.

10. An optical element comprising:
an incident portion, a first reflective portion, a second reflective portion, and an exit portion sequentially formed along an optical path,
wherein a size of the incident portion is greater than a size of the exit portion.

11. The optical element of claim 10, wherein the first reflective portion and the exit portion have different size of radii of curvature.

12. The optical element of claim 10, wherein the first reflective portion and the exit portion are disposed adjacently and alongside each other.

13. The optical element of claim 10, wherein the exit portion is formed to be convex or concave.

14. The optical element of claim 10, wherein the incident portion is formed to be convex or concave.

15. The optical element of claim 10, further including a light-blocking member disposed on the first reflective portion and the second reflective portion.

16. A camera module comprising:
the optical element of claim 10;
an imaging lens system disposed on an object side of the incident surface; and
an image sensor disposed to oppose the exit surface.
